(19) United States
(12) Patent Application Publication
(10) Pub. No.: US 2016/0284488 A1
(43) Pub. Date: Sep. 29, 2016

(54) LUMINOUS PRESS KEY MODULE

(71) Applicant: Changshu Sunrex Technology Co., Ltd., Changshu (CN)

(72) Inventor: Qing ZHANG, Changshu (CN)

(21) Appl. No.: 14/669,686

(22) Filed: Mar. 26, 2015

(51) Int. Cl. H01H 13/02; H01H 13/50

(52) U.S. Cl. CPC H01H 13/023; H01H 13/50

(57) ABSTRACT

A luminous press key module includes a circuit board unit, a pressing unit, and a light emitting unit. The pressing unit is disposed on the circuit board unit and includes a key cap which is movable in a movement direction relative to the circuit board unit between a pressed, position and a raised position. The light emitting unit is disposed between the circuit board unit and the key cap, and includes a light emitting member, and a light-shielding layer which is coated on an outer surface of the light emit ting member, and which is formed with a through hole corresponding in position to a light-permeable region of the key cap so as to permit light generated by the light emitting member to pass therethrough and to the light-permeable region.

### FIELD

The disclosure relates to a press key module, and more particularly to a luminous press key module.

### BACKGROUND

Referring to FIG. 1, a conventional luminous press key module is capable of illuminating and indicating an operational status thereof. The conventional luminous press key module includes a base plate 91, a membrane circuit board 92 disposed on the base plate 91 and having a conductive portion 921, a key cap 93 spaced apart from the membrane circuit board 92, a restoring member 94 having a contact portion 941 and disposed between the membrane circuit board 92 and the key cap 93, a scissor linkage 95 connecting the base plate 91 and the key cap 93, and a light-emitting unit 96 disposed between the membrane circuit board 92 and the key cap 93. When the key cap 93 is pressed, the scissor linkage 95 is compressed and the restoring member 94 is deformed so that the contact portion 941 contacts the conductive portion 921 of the membrane circuit board 92 to produce an electrical signal.

The light-emitting unit 96 includes a light-emitting diode 961 disposed on the membrane circuit board 92 and facing the key cap 93, and a light-shielding cover 962 covering the light-emitting diode 961 and having a top surface which is formed with a through hole 963 corresponding in position to a perforation 931 formed in the key cap 93 such that light emitted from the light-emitting diode 961 can sequentially pass through the through hole 963 and the perforation 931 for illumination of the key cap 93. As such, the letters, symbols, or numbers on the key cap 93 can be identified in a dark environment. The light-shielding cover 962 is mounted on the membrane circuit board 92 via an adhesive material.

Since the size of the light-shielding cover 962 needs to be larger than that of the light-emitting diode 961 to completely cover the light-emitting diode 961, a space is usually formed between the light-shielding cover 962 and the light-emitting diode 961. As such, downward movement of the key cap 33, the scissor linkage 95, and the restoring member 94 may be obstructed by the light-shielding cover 962, and the contact portion 941 of the restoring member 94 may not be able to contact the conductive portion 921 of the membrane circuit board 92. As a result, the electrical signal may not be successfully generated. Moreover, if the adhesion between the light-shielding cover 962 and the membrane circuit board 92 is not strong enough, displacement or detachment of the light-shielding cover 962 may occur, thereby affecting the transmission of light and increasing the defective rate during manufacture.

### SUMMARY

Therefore, an object of the disclosure is to provide a luminous press key module that can alleviate at least one of the drawbacks of the prior arts.

According to the disclosure, the luminous press key module includes a circuit board unit, a pressing unit and a light emitting unit. The pressing unit is disposed on the circuit board unit and includes a key cap which is spaced apart from the circuit board unit, which has a light-permeable region, and which is movable in a movement direction relative to the circuit board unit between a pressed position, where the key cap is proximate to the circuit board unit, and a raised position, where the key cap is away from the circuit board unit. The light emitting unit is disposed between the circuit board unit and the key cap, and includes a light emitting member which is electrically connected to the circuit board unit, and a light-shielding layer which is coated on an outer surface of the light emitting member, and which is formed with a through hole corresponding in position to the light-permeable region of the key cap so as to permit light generated by the light emitting member to pass therethrough and to the light-permeable region.

### BRIEF DESCRIPTION OF THE DRAWINGS

Other features and advantages of the disclosure will become apparent in the following detailed description of the embodiment with reference to the accompanying drawings, of which:

FIG. 1 is a sectional view illustrating a conventional luminous press key module;

FIG. 2 is an assembled perspective view illustrating an embodiment of a luminous press key nodule according to the disclosure;

FIG. 3 is an exploded perspective view of the embodiment;

FIG. 4 is a sectional view of the embodiment, illustrating a key cap at a raised position;

FIG. 5 is a view similar to FIG. 4, but illustrating the key cap at a pressed position; and

FIG. 6 is a fragmentary enlarged sectional view of the embodiment, illustrating a light path of a light emitting unit.

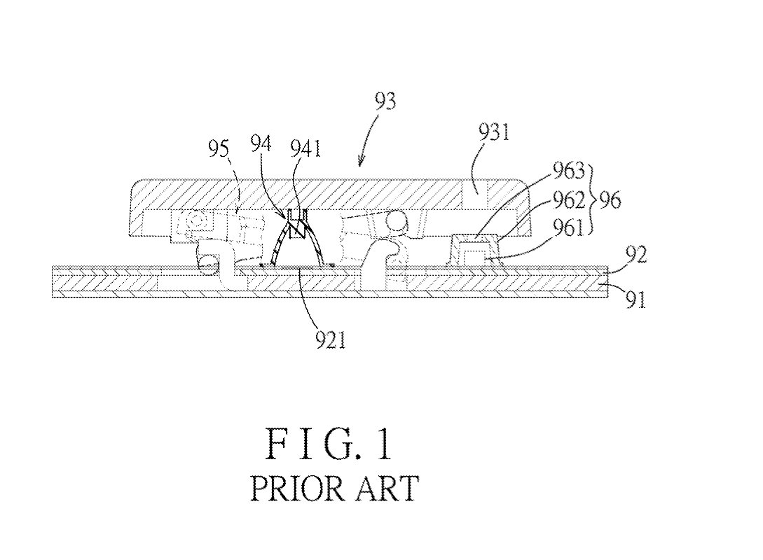

### DETAILED DESCRIPTION

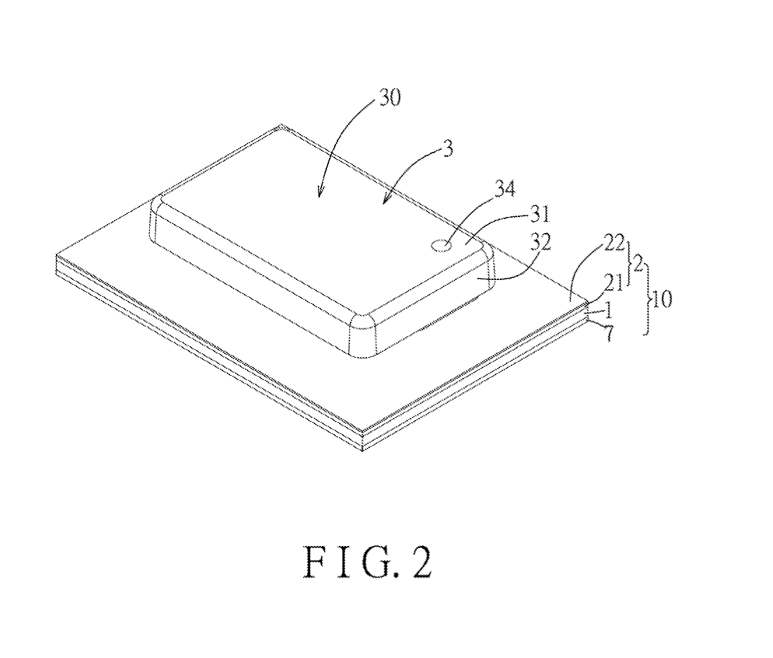

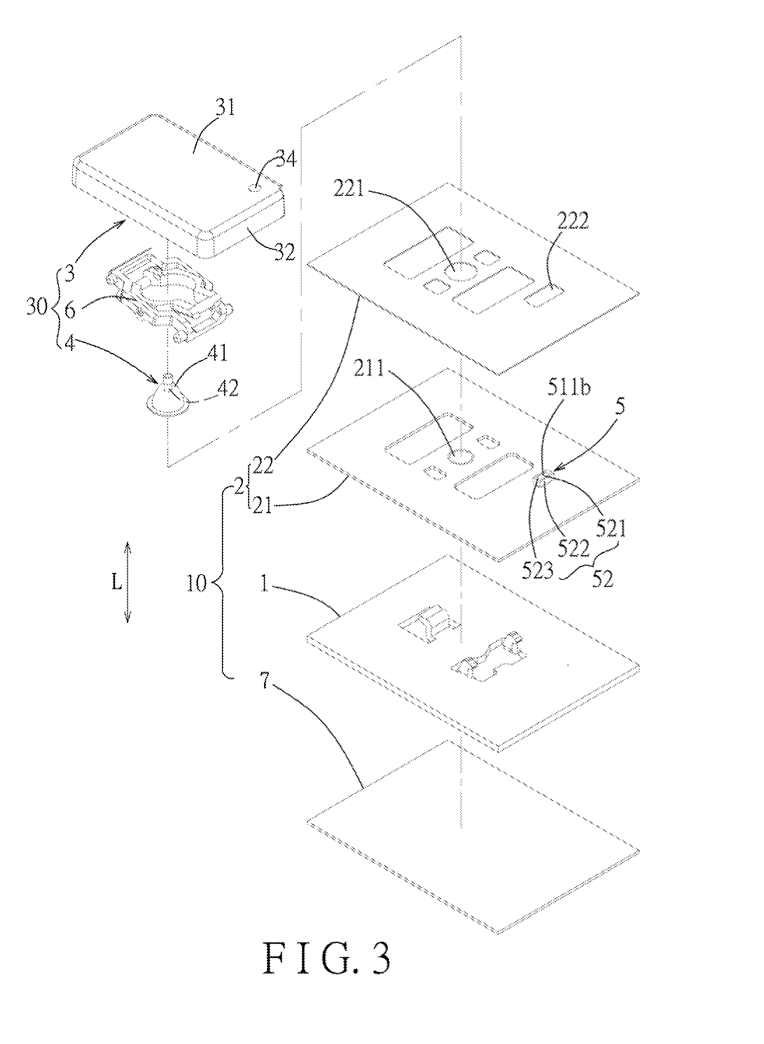

Referring to FIGS. 2 to 4, a luminous press key module according to an embodiment of the disclosure is shown to include a circuit board unit 10, a pressing unit 30, and a light emitting unit 5.

The circuit board unit 10 includes a base plate 1, a membrane circuit board 2 disposed on a side of the base plate 1, and a bottom cover 7 disposed on another side of the base plate 1 oppositely of the membrane circuit board 2. The membrane circuit board 2 includes a circuit board body 21 disposed on the base plate 1, and an insulating layer 22 disposed on the circuit board body 21. The circuit board body 21 has a conductive portion 211 that may be configured as a membrane switch or a trigger switch. The insulating layer 22 has a first opening 221 corresponding in position to the conductive portion 211 for accommodating the conductive portion 211 therein, and a second opening 222 corresponding in position to the light emitting unit 5 for allowing the light emitting unit 5 to pass therethrough.

The pressing unit 30 is disposed on the circuit board, and includes a key cap 3, a scissors linkage 6, and a restoring member 4.

The key cap 3 is spaced apart from the circuit board unit 10, and includes a key cap body 31 that has a light-permeable region 34, and a peripheral flange 32 that extends from the key cap body 31 toward the circuit board unit 10.

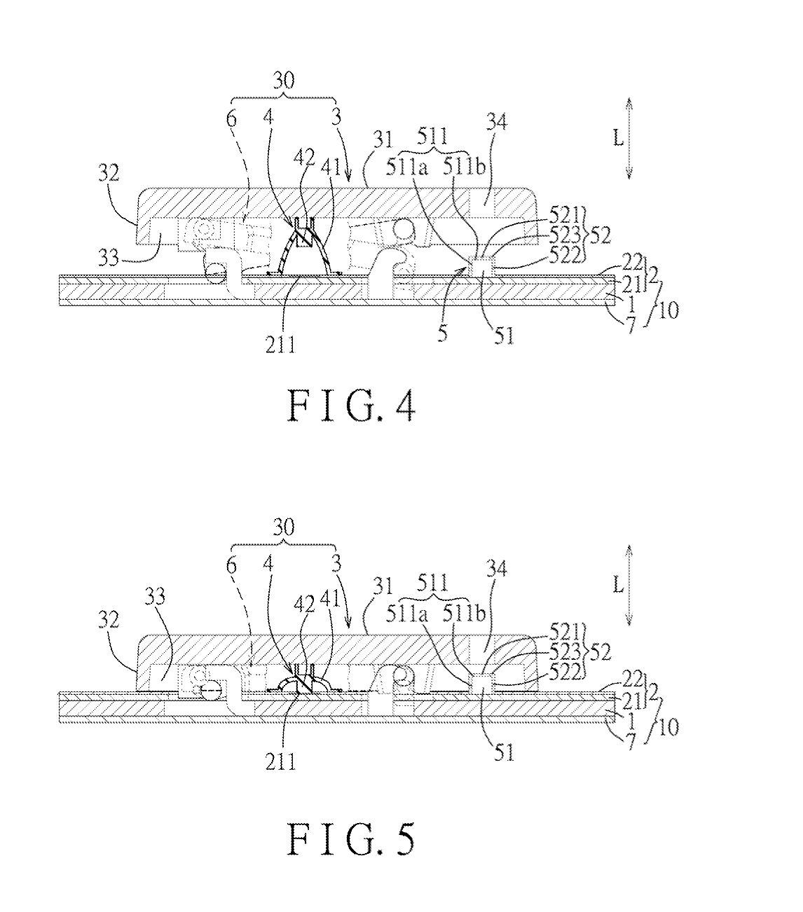

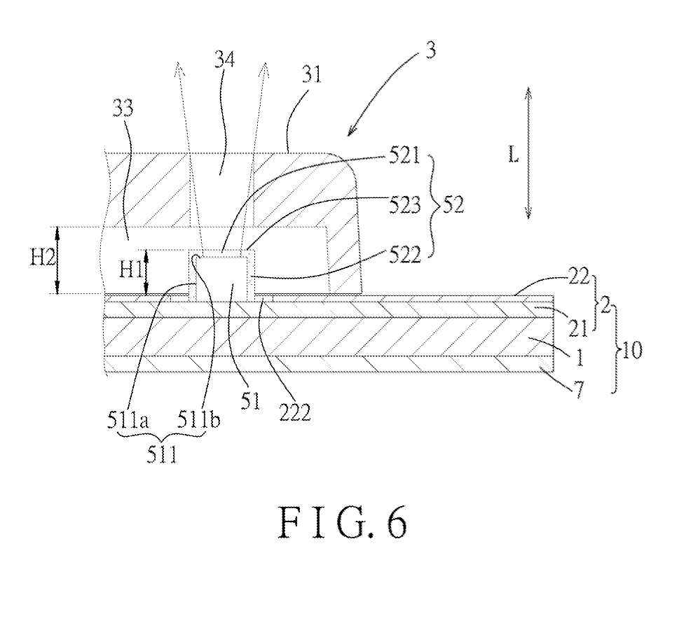

Referring to FIG. 4 and FIG. 5, the key cap 3 is movable in a movement direction (L) relative to the circuit board unit 10 between a pressed position, where the key cap 3 is proximate to the circuit board unit 10 (see FIG. 5), and a raised position, where the key cap 3 is away from the circuit board unit 10 (see FIG. 4). The peripheral flange 32 cooperates with the key cap body 31 to confine an accommodating space 33 for accommodating the light emitting unit 5 when the key cap 3 is at the pressed position. With additional reference to FIG. 6, the accommodating space 33 has a height (H2) greater than a height (H1) of the light emitting unit 5 in the movement direction (L).

In this embodiment, the light-permeable region 34 of the keycaps is configured as a perforation. It should be noted that the form of the light-permeable region 34 is not restricted. In a variation of the embodiment, the light-permeable region 34 can be made of a light-permeable material. Furthermore, the shapes of the light-permeable region 34 can be letters, symbols, figures, numbers, etc.

The scissors linkage 6 is disposed between and pivotally connected to the circuit board unit 10 and the key cap 3 such that the key cap 3 can be smoothly moved between the pressed position and the raised position. It should be noted that the configuration of the scissors linkage 6 is not limited to that disclosed in the embodiment. The scissors linkage 6 may be replaced by other type of linkage structures in other variations of the embodiment as long as the key cap 3 can be smoothly moved between the pressed position and the raised position.

The restoring member 4 is disposed between the circuit board unit 10 and the key cap 3. To be more specific, the restoring member 4 is disposed on the insulating layer 22 of the circuit board unit 10 and corresponds in position to the conductive portion 211. The restoring unit 4 has a dome-like restoring portion 41 and a contact portion 42. The dome-like restoring portion 41 is fixedly disposed on the insulating layer 22 and abuts against the key cap 3. The contact portion 42 projects out of an inner surface of the dome-like restoring portion 41. The contact portion 32 is spaced apart from the conductive portion 211 at the raised position and contacts the conductive portion 211 at the pressed position to produce an electrical signal.

When an external force is exerted on the key cap 3, the key cap 3 moves toward the circuit board unit 10 and the scissors linkage 6 is compressed; at this time, the dome-like restoring portion 41 is also compressed and deformed. As the key cap 3 reaches the pressed position, the contact portion 42 contacts the conductive portion 211 to produce the electrical signal. When the external force is removed, the dome-like restoring portion 41 provides a restoring force for biasing the key cap 3 to move back to the raised position.

Referring to FIG. 5 and FIG. 6, the light emitting unit 5 is disposed between the circuit board unit 10 and the key cap 3. The light emitting unit 5 includes a light emitting member 51 which is electrically connected to the circuit board unit 10, and a light-shielding layer 52 which is coated on an outer surface 511 of the light emitting member 51, and which is formed with a through hole 521 corresponding in position to the light-permeable region 34 of the key cap 3 so as to permit light generated by the light emitting member 51 to pass therethrough and to the light-permeable region 34.

The outer surface 511 of the light emitting member 51 has a top surface portion 511b, and a peripheral portion 511a that is connected to an outer periphery of the top surface portion 511b. The light-shielding layer 52 has a top light-shielding portion 523 that is coated on the top surface portion 511b and that defines the through hole 521, and a peripheral light-shielding portion 522 that is coated on the peripheral portion 511a and that is connected to an outer periphery of the top light-shielding portion 523.

In this embodiment, the light emitting member 51 is a light emitting diode (LED). The light-shielding layer 52 is coated on the outer surface 511 of the light-emitting member 51 by spray coating, electroplating, or vacuum plating. During manufacture, an entire wafer including a plurality of light emitting members 51 is first coated with the light-shielding layer 52 using one of the aforementioned techniques, then formed with the through holes 521 of the light emitting members 51 using laser engraving. The wafer is then cut to form the individual light emitting units 5.

The light-shielding layer 52 is made of a light-impermeable material. In this embodiment, the light-shielding layer 52 is made of a metal selected from the group consisting of aluminum and silver.

Since the light-shielding layer 52 is coated directly on the outer surface 511 of the light emitting member 51, no spacing is formed between the top surface portion 511b and the top light-shielding portion 523, or between the peripheral portion 511a and the peripheral light-shielding portion 522. As such, the height (H1) of the light emitting unit 5 can be effectively reduced. Moreover, the height (H1) of the light emitting unit 5 is designed to be smaller than the height (H2) of the accommodating space 33. Thus, when the key cap 3 is pressed to the pressed position, the key cap 3 would not abut against the light-shielding layer 52, and movement of the scissors linkage 6 and the restoring member 4 would not be obstructed, thereby ensuring contact between the contact portion 42 of the restoring member 4 and the conductive portion 211 of the membrane circuit board 2 for successful generation of the electrical signal.

As shown in FIG. 6, since the peripheral portion 511a of the light emitting member 51 is completely covered by the peripheral light-shielding portion 522 of the light-shielding layer 52, and part of the top surface portion 511b is covered by the top light-shielding portion 523, the light emitted from the top surface portion 511b (as shown by the arrow) may sequentially pass through the through hole 521 and the light-permeable region 34 for illumination of the key cap 3.

To sum up, compared with the conventional light-shielding cover, the light-shielding layer 52 occupies a smaller space and the height (H1) of the light emitting unit 5 is reduced. Therefore, movement of the key cap 3, the scissors linkage 6, and the restoring unit 4 would not be obstructed, thereby ensuring contact between the restoring unit 4 and the membrane circuit board 2 to produce the electrical signal. Furthermore, the light-shielding layer 52 would not displace or detach from the light emitting unit 5, thus reducing the defective rated during manufacture.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A luminous press key module comprising:
a circuit board unit;
a pressing unit that is disposed on said circuit board unit and that includes a key cap which is spaced apart from said circuit board unit, which has a light-permeable region, and which is movable in a movement direction relative to said circuit board unit between a pressed position, where said key cap is proximate to said circuit board unit, and a raised position, where said key cap is away from said circuit board unit; and
a light emitting unit that is disposed between said circuit board unit and said key cap, and that includes a light emitting member which is electrically connected to said circuit board unit, and a light-shielding layer which is coated on an outer surface of said light-emitting member, and which is formed with a through hole corresponding in position to said light-permeable region of said key cap so as to permit light generated by said light emitting member to pass therethrough and to said light-permeable region.

2. The luminous press key module as claimed in claim 1, wherein said outer surface of said light emitting member has a top surface portion, said light-shielding layer having a top light-shielding portion that is coated on said top surface portion and that defines said through hole.

3. The luminous press key module as claimed in claim 2, wherein said outer surface of said light emitting member further has a peripheral portion that is connected to an outer periphery of said top surface portion, said light-shielding layer further having a peripheral light-shielding portion that is coated on said peripheral portion, and that is connected to an outer periphery of said top light-shielding portion.

4. The luminous press key module as claimed in claim 1, wherein said key cap confines an accommodating space for accommodating said light emitting unit when said key cap is at the pressed position, said accommodating space having a height in the movement direction greater than that of said light emitting unit.

5. The luminous press key module as claimed in claim 2, wherein said key cap confines an accommodating space for accommodating said light emitting unit when said key cap is at the pressed position, said accommodating space having a height in the movement direction greater than that of said light emitting unit.

6. The luminous press key module as claimed in claim 3, wherein said key cap confines an accommodating space for accommodating said light emitting unit when said key cap is at the pressed position, said accommodating space having a height in the movement direction greater than that of said light emitting unit.

7. The luminous press key module as claimed in claim 1, wherein said light-permeable region of said key cap is configured as a perforation.

8. The luminous press key module as claimed in claim 1, wherein said, pressing unit further includes a restoring member that is disposed between said circuit board unit and said key cap, and that abuts against said key cap so as to provide a restoring force for biasing said key cap to move to the raised position.

9. The luminous press key module as claimed in claim 8, wherein said pressing unit further includes a scissors linkage disposed between and pivotally connected to said circuit board unit and said key cap.

10. The luminous press key module as claimed in claim 1, wherein said key cap includes a key cap body, and a peripheral flange that extends from said key cap body toward said circuit board unit, and that cooperates with said key cap body to confine an accommodating space for accommodating said light emitting unit when said key cap is at the pressed position, said accommodating space having a height in the movement direction greater than that of said light emitting unit.

11. The luminous press key module as claimed in claim 1, wherein said light-shielding layer is coated on said outer surface of said light emitting member by one of spray coating, electroplating and vacuum plating techniques.

12. The luminous press key module as claimed in claim 11, wherein said light-shielding layer of said light emitting unit is made of a light-impermeable material.

13. The luminous press key module as claimed in claim 12, wherein said light-impermeable material is a metal.

14. The luminous press key module as claimed in claim 13, wherein said metal is selected from the group consisting of aluminum and silver.
